(19) United States
(12) Patent Application Publication
(10) Pub. No.: US 2010/0106897 A1
(43) Pub. Date: Apr. 29, 2010

(54) STORAGE DEVICE, DISK DEVICE, WRITE DETERMINING METHOD, AND CONTROL DEVICE

(75) Inventor: Noritsugu YOSHIMURA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/649,187

(22) Filed: Dec. 29, 2009

Related U.S. Application Data
(63) Continuation-in-part of application No. PCT/JP2007/063084, filed on Jun. 29, 2007.

(51) Int. Cl. G06F 12/16; G06F 12/02

(52) U.S. Cl. 711/103; 711/161; 711/E12.008; 711/E12.103

(57) ABSTRACT

According to one embodiment, a storage device divides and writes into pages a management information table for managing addresses at which data are written. The storage device includes: a writing module configured to write a duplicate of a last page of the management information table after writing the management information table divided into the pages; an acquiring module configured to acquire the last page and the duplicate of the last page written by the writing module; and a determining module configured to determine whether the writing of the management information table has been successful, by comparing the last page and the duplicate of the last page acquired by the acquiring module with each other, or by checking whether the duplicate of the last page has been written by the writing module.

### CROSS-REFERENCE TO RELATED APPLICATIONS

This application is a continuation of PCT international application Ser. No. PCT/JP2007/063084 filed on Jun. 29, 2007 which designates the United States, the entire contents of which are incorporated herein by reference.

### BACKGROUND

1. Field

One embodiment of the invention relates to a storage device, a disk device, a write determining method, and a control device for determining whether a write defect has occurred due to an unexpected power failure during writing of a management information table in a nonvolatile memory.

2. Description of the Related Art

Management of data in a nonvolatile memory is performed by providing a management information table for associating stored data with data addresses in a management area in the nonvolatile memory, and updating the management information table as needed. Based on the management information table, the nonvolatile memory performs data reading and writing.

Conventionally, correctness of a management information table determined based on whether sets of stamp information stored word by word in a management information table as illustrated in FIG. 12 match. A nonvolatile memory is managed by generation management. If a write defect is detected with unmatched sets of stamp information, a management information table of a previous generation is used. Accordingly, at least data managed in the management information table of the previous generation is guaranteed. To minimize data destruction, it has to be checked whether the management information table is the correct one.

As a conventional technique of checking data correctness, a memory card device has been proposed (see Japanese Patent Application Publication (KOKAI) No. 5-46490, for example). The memory card has: an EEPROM capable of reading and writing in bytes, and divided into a plurality of pages each of several bytes; an error detector that detects presence of an error in each page; an error flag writing unit that records an error flag indicating presence of an error in each page with a certain page being an error flag area among the pages; a data writing and replacing unit that replaces the data written in a page with an error with an empty page; an address writing unit that writes a replacement target address that is replaced by a data replacing unit into the page with the error; and a data reading unit that identifies an error page by referring to the error flag area, identifies the replacement target address by reading byte data from the error page, and reads data from a replacement page based on the identified address.

Data writing in a nonvolatile memory is performed page by page, with each page having a certain size. However, when a write defect is caused by a power failure in a computer or a connection fault between the computer and the nonvolatile memory, it is not possible to determine which parts of the page have and have not been successfully written. Even if the sets of stamp information have been read correctly, there is no guarantee that other parts have been correctly written, and it is not possible to determine the success of the writing by the mere collation between the sets of stamp information (see FIG. 12). The use of a management information table without any data guarantee may lead to serious data destruction.

Furthermore, Japanese Patent Application Publication (KOKAI) No. 5-46490 does not disclose anything about checking the correctness with respect to a region (such as the error flag area) for managing the data stored in the memory card device.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary functional block diagram illustrating the functions of each storage device according to a first embodiment and a second embodiment of the invention;

FIG. 2 is an exemplary diagram illustrating the structure of each storage device in the first embodiment and the second embodiment;

FIG. 3 is an exemplary diagram illustrating a state of a management information table (having a defect in duplicated page data) stored in the storage device in the first embodiment;

FIG. 4 is an exemplary diagram illustrating a state of the management information table (having a defect in intermediate data) stored in the storage device in the first embodiment;

FIG. 5 is an exemplary flowchart illustrating a writing operation of the storage device in the first embodiment;

FIG. 6 is an exemplary flowchart illustrating a determining operation of the storage device in the first embodiment;

FIG. 7 is an exemplary block diagram illustrating a disk device comprising the storage device in the first embodiment;

FIG. 8 is an exemplary diagram illustrating a state of a management information table (having a defect in duplicated page data) stored in the storage device in the second embodiment;

FIG. 9 is an exemplary diagram illustrating a state of the management information table (having a defect in intermediate data) stored in the storage device in the second embodiment;

FIG. 10 is an exemplary flowchart illustrating a writing operation of the storage device in the second embodiment;

FIG. 11 is an exemplary flowchart illustrating a determining operation of the storage device in the second embodiment; and

FIG. 12 illustrates a management information table determining method that is implemented in a conventional nonvolatile memory.

### DETAILED DESCRIPTION

Various embodiments according to the invention will be described hereinafter with reference to the accompanying drawings. In general, according to one embodiment of the invention, a storage device is configured to divide and write into pages a management information table for managing addresses at which data are written. The storage device comprises: a writing module configured to write a duplicate of a last page of the management information table after writing the management information table divided into the pages; an acquiring module configured to acquire the last page and the duplicate of the last page written by the writing module; and a determining module configured to determine whether the writing of the management information table has been successful, by comparing the last page and the duplicate of the last page acquired by the acquiring module with each other, or by checking whether the duplicate of the last page has been written by the writing module.

According to another embodiment of the invention, a storage device is configured to divide and write into pages a management information table for managing addresses at which data are written. The storage device comprises: a writing module configured to acquire unique data different from the management information table from an outside source to write the unique data, after writing the management information table divided into the pages; an acquiring module configured to acquire the unique data that have been written by the writing module as first information, and further acquires the unique data as second information from the outside source; and a determining module configured to determine whether the writing of the management information table has been successful, by comparing the first information and the second information acquired by the acquiring module with each other, or checking whether the unique data have been written by the writing module.

According to still another embodiment of the invention, a disk device with a storage device to divide and write into pages a management information table for associating data with addresses at which the data are written comprises: a writing module configured to write a duplicate of a last page of the management information table after writing the management information table divided into the pages; an acquiring module configured to acquire the last page and the duplicate of the last page written by the writing module; and a determining module configured to determine whether the writing of the management information table has been successful, by comparing the last page and the duplicate of the last page acquired by the acquiring module with each other, or by checking whether the duplicate of the last page has been written by the writing module.

According to still another embodiment of the invention, a writing determining method determines writing of a management information table for managing addresses at which data are written at a storage device that divides and writes into pages the management information table. The writing determining method comprises: writing a duplicate of a last page of the management information table after writing the management information table divided into the pages; acquiring the last page and the duplicate of the last page written; and determining whether the writing of the management information table has been successful, by comparing the acquired last page and duplicate with each other, or by checking whether the duplicate of the last page has been written.

According to still another embodiment of the invention, a control device is for a storage device configured to divide and write into pages a management information table for managing addresses at which data are written. The control device comprises: a write controller configured to instruct writing of a duplicate of a last page of the management information table after the management information table divided into the pages is written; an acquiring controller configured to control acquirement of the last page and the duplicate of the last page written; and a determining module configured to determine whether the writing of the management information table has been successful, by comparing the last page and the duplicate of the last page acquired by the acquiring controller with each other, or by checking whether the duplicate of the last page has been written.

According to still another embodiment of the invention, a control device is for a storage device configured to divide and write into pages a management information table for managing addresses at which data are written. The control device comprises: a write controller configured to control acquirement and writing of unique data different from the management information table from an outside source, after the management information table divided into the pages is written; an acquiring controller configured to control acquirement of the unique data that have been written as first information, and further acquirement of the unique data as second information from the outside source; and a determining module configured to determine whether the writing of the management information table has been successful, by comparing the acquired first information and second information with each other, or checking whether the unique data have been written.

### First Embodiment

First, the structure of a storage device according to a first embodiment is described. The storage device of the first embodiment is described as a NAND-type nonvolatile memory.

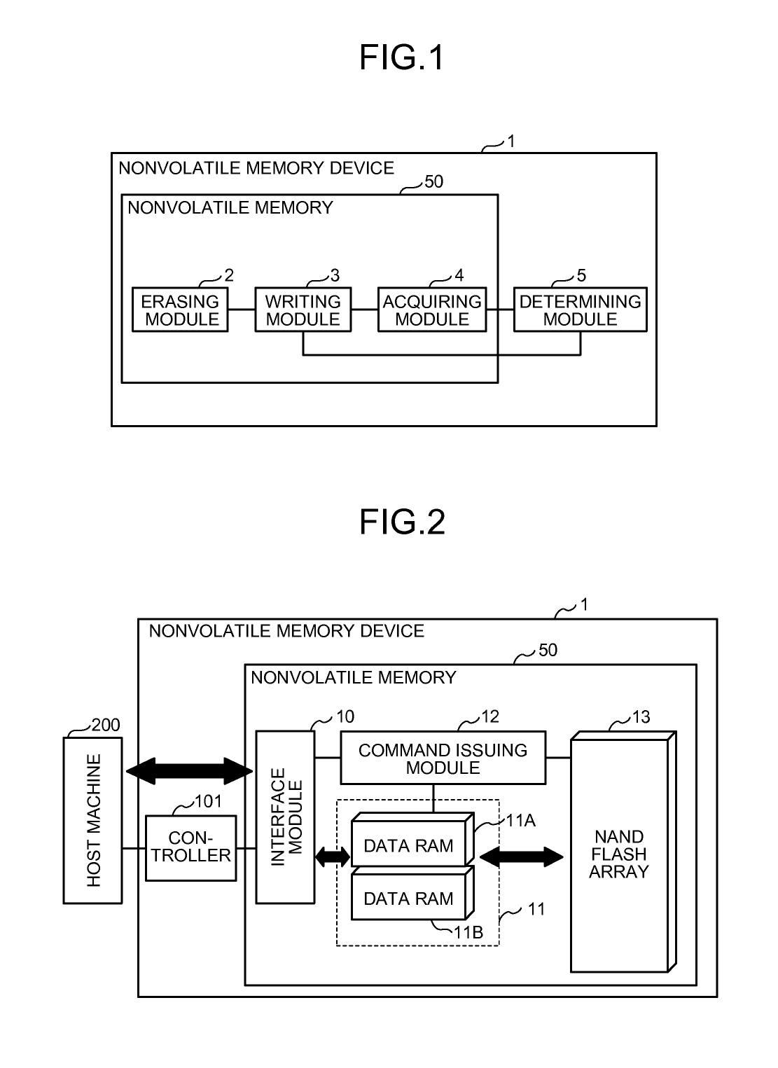

FIG. 1 illustrates the functional blocks of the storage device according to the first embodiment. In a nonvolatile memory device 1, a nonvolatile memory 50 comprises an erasing module 2, a writing module 3, and an acquiring module 4, and further comprises a determining module 5 in a controller 101 (a control device) interposed between the nonvolatile memory 50 and a host machine 200. The erasing module 2, the writing module 3, and the acquiring module 4 are under the control of a firmware program of the controller 101.

The erasing module 2 erases an existing management information table on a block basis, and the writing module 3 writes a management information table that is divided into pages, into the block erased by the erasing module 2. The writing module 3 then writes a duplicated page of the last page of the management information table.

The acquiring module 4 acquires the duplicated page of the last page written by the writing module 3, and further acquires the last page of the management information table written by the writing module 3. The determining module 5 either compares the last page with the duplicated page of the last page acquired by the acquiring module 4, or determines whether the duplicated page of the last page has been written by the writing module 3. By doing so, the determining module 5 determines whether the writing in the management information table is successful.

FIG. 2 illustrates the structure of the storage device according to the first embodiment. The nonvolatile memory device 1 is formed with the nonvolatile memory 50 and the controller 101 that controls the nonvolatile memory 50 according to the firmware program. The nonvolatile memory 50 further comprises an interface module 10, a data RAM 11, a command issuing module 12, and a NAND flash array 13.

The interface module 10 receives and outputs data between the nonvolatile memory 50 and the host machine 200 (the host machine 200 being a computer connected to the nonvolatile memory device 1), and also receives and outputs control commands from the controller 101. The data RAM 11 is a volatile memory that functions as a read and write buffer for the NAND flash array 13. The command issuing module 12 issues commands such as a command to erase an existing management information table and a command to write a management information table. The NAND flash array 13 stores data in a nonvolatile manner. Although the data RAM 11 has two volatile memories (the data RAM 11A and the data RAM 11B in FIG. 2) in the first embodiment, the number of volatile memories is not limited, and it is possible to use one or more volatile memories.

How each of the components illustrated in FIG. 2 functions is now described by way of examples of a data write operation and a data read operation performed onto the nonvolatile memory device 1 from the host machine 200.

The write operation is briefly described. Where data already exists, the controller 101 erases the existing data on a block basis before writing data, with each block containing a plurality of pages. The erasing of the existing data is carried out by the command issuing module 12 issuing an erase command, and all “1” data (ALL(1)) is stored in the erased block.

Data transmitted from the host machine 200 is transferred to the data RAM 11 via the interface module 10, and one-page data is stored. After that, in accordance with a command from the controller 101, the command issuing module 12 issues a write command. The one-page data is then transferred from the data RAM 11 to the NAND flash array 13, and is written into the NAND flash array 13. After the writing, the command issuing module 12 sends a write command completion notification to the controller 101.

The above procedures are repeated, thereby writing all the subject data into the NAND flash array 13.

Next, the read operation is briefly described. In the nonvolatile memory device 1 having received a load command from the host machine 200, the command issuing module 12 issues a command to load data from the NAND flash array 13 into the data RAM 11, based on the command from the controller 101. After that, the one-page of the subject data is stored into the data RAM 11. The command issuing module 12 sends a load command completion notification to the controller 101, and the host machine 200 obtains page-by-page data from the data RAM 11 via the interface module 10.

The above procedures are repeated, thereby loading all the subject data into the host machine 200.

Although the above operations are performed to handle data, management information tables for managing data may be handled in those operations.

As for the correspondence between the functional blocks illustrated in FIG. 1 and the structure illustrated in FIG. 2, the function of the erasing module 2 is realized by the interface module 10, the command issuing module 12, and the NAND flash array 13, in accordance with a command from the controller 101. The function of the writing module 3 is realized by the interface module 10, the data RAM 11, the command issuing module 12, and the NAND flash array 13, in accordance with a command from the controller 101. The acquiring module 4 is realized by the data RAM 11, the command issuing module 12, and NAND flash array 13, in accordance with a command from the controller 101. The determining module 5 is realized by a firmware program of the controller 101.

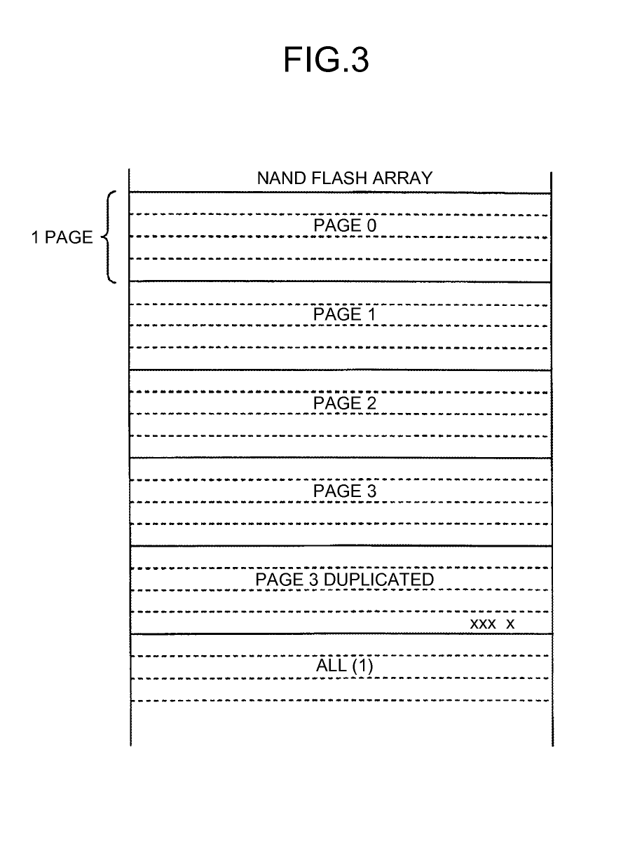

Referring now to FIG. 3 illustrating the storage state of a management information table of the nonvolatile memory device 1, the determining operation of the first embodiment is briefly described. FIG. 3 illustrates a situation where a management information table that uses the four pages of Page 0 to Page 3 is stored in a predetermined region of the NAND flash array 13. In the NAND flash array 13, a duplicated page of the last page (Page 3 Duplicated) is further stored on the page after the last page (Page 3) of the management information table.

FIG. 3 illustrates an example case where the duplicated page of the last page (Page 3 Duplicated) has a write defect caused by unexpected power discontinuity or the like (“x” representing defective write data in FIG. 3).

As for the determination of successfulness of writing in the management information table in the first embodiment, the last page (Page 3) is compared with the duplicated page of the last page (Page 3 Duplicated). If the last page (Page 3) and the duplicated page of the last page (Page 3 Duplicated) are the same, the writing is determined to be successful. If not, the writing is determined to be unsuccessful. The last page is decided by confirming the duplicated page and the pages erased by the erasing module 2 (the erased pages being hereinafter referred to as “ALL(1)”). Since all the values in the block erased by the erasing module 2 are “1”, all the values in each of the pages in the erased block are of course “1”.

In the case illustrated in FIG. 3, the last page (Page 3 of the management information table and the duplicated page of the last page (Page 3 Duplicated), which should be the same as each other when the writing is normally completed, are not the same as each other, since there is defective write data. Therefore, the determining module 5 of the nonvolatile memory device 1 cannot determine that Page 3 is the last page (cannot determine whether “Page 3 Duplicated” is Page 4 or a duplicated page of Page 3). As a result, the determining module 5 cannot confirm that there is a duplicated page of the last page, and determines that the writing in the management information table is unsuccessful.

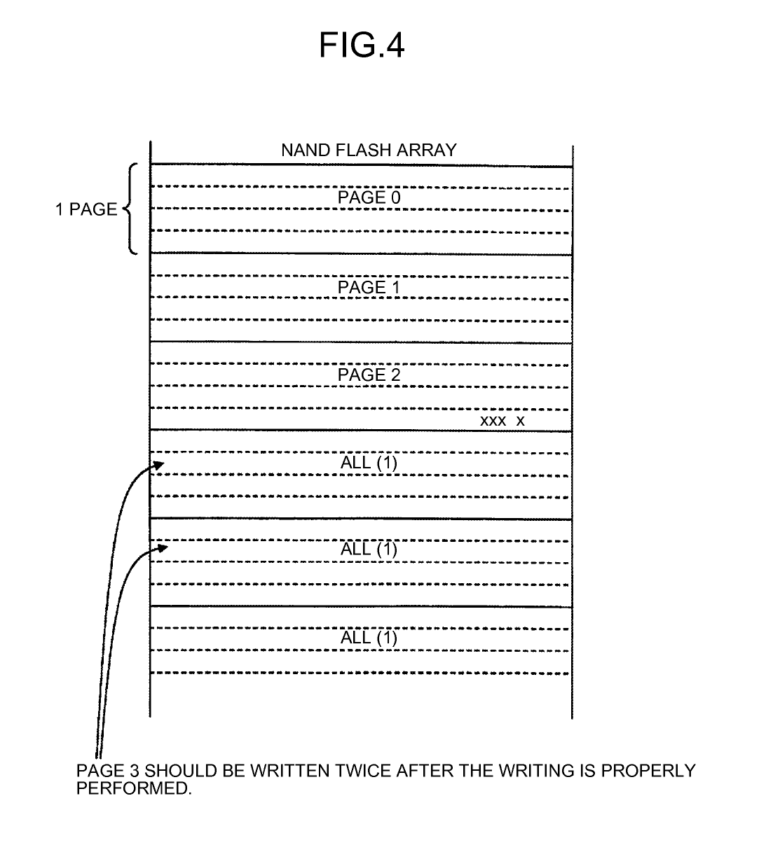

FIG. 4 illustrates an example case where a write defect is caused due to unexpected power discontinuity or the like during a writing operation in the management information table. The example case illustrated in FIG. 4 is a case where a write defect is caused while Page 2 is being written, and “x” represents defective write data. In the example case illustrated in FIG. 4, duplicated data cannot be confirmed, and the writing in the management information table is determined to be unsuccessful.

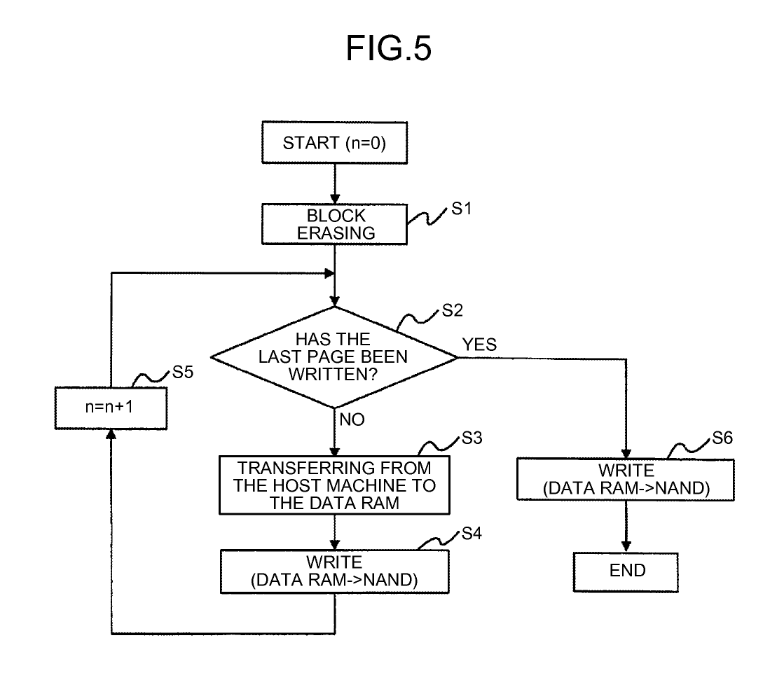

Referring now to the flowchart of FIG. 5, a management information table updating operation (from erasing of an existing management information table to writing of a new management information table) of the nonvolatile memory device 1 according to the first embodiment is described. The management information table to be written is divided into pages, and the page number of an object in the management information table is regarded as a variable n (0 being its initial value).

First, the erasing module 2 erases the block storing a management information table (S1). The erasing module 2 writes data that is to be “ALL(1)” in the block storing the management information table, thereby erasing the existing management information table.

The writing module 3 then determines whether the writing operation has reached the last page (or whether there is still a page to be written) (S2). If there is a page to be written (No at S2), the writing module 3 obtains the data of one page of the management information table from the host machine 200 via the interface module 10, and writes the data into the data RAM 11 (S3).

After that, the writing module 3 issues a write command, so as to write the data of the one page of the management information table stored in the data RAM 11 into the NAND flash array 13 (S4).

After writing the data of the one page of the management information table of the NAND flash array 13, the writing module 3 adds “1” to the variable n (S5). The updating operation then returns to the determining procedure of step S2, and the procedures of steps S2 through S5 are repeated until the last page is written.

When the last page of the management information table is written (Yes at S2), the writing module 3 writes the last page of the management information table remaining in the data RAM 11 into the NAND flash array 13 (S6)

The management information table written into the NAND flash array 13 through the above procedures is as illustrated in FIG. 3. In FIG. 3, a management information table divided into four pages (from Page 0 to Page 3) is written, and the last page (Page 3) is duplicated at step S6. The duplicate (Page 3 Duplicated) is written in the page after the last page. Since the page after the duplicated page of the last page (Page 3 Duplicated) has been erased by the erasing module 2, ALL(1) data is written in the page.

In FIG. 3, defective data is included in the duplicated page of the last page. However, if the management information table is normally written, defective data is not caused, and the duplicated page of the last page (Page 3 Duplicated) is the same data as the last page (Page 3).

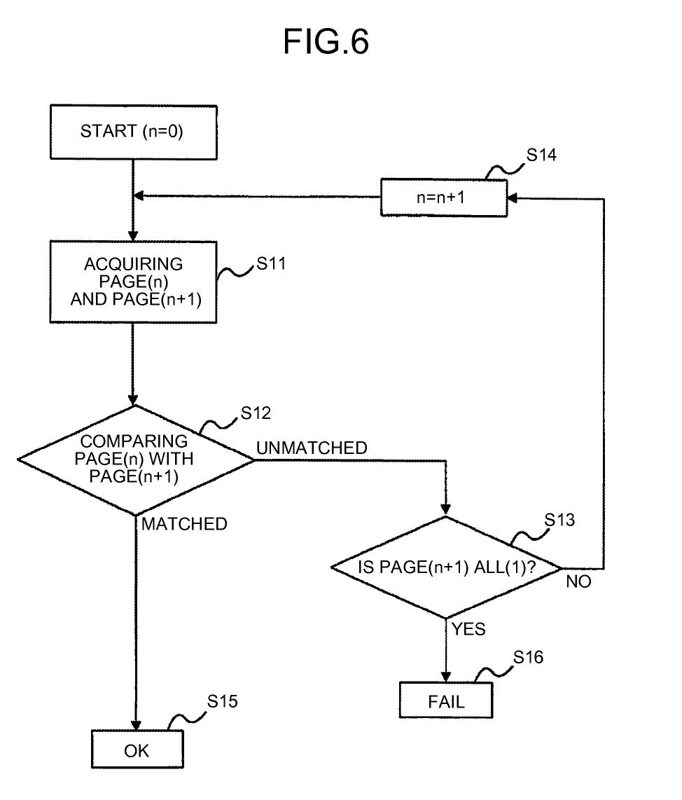

Referring now to the flowchart of FIG. 6, a method of determining whether writing in the management information table written in the above manner is successful is described. The determining operation may be performed when required, or may be performed immediately before data is read out.

The acquiring module 4 acquires the page having the page number n (0 being the initial value of the variable n) and the page having the page number n+1 (S11). The determining module 5 makes a comparison to determine whether the data of the two pages acquired by the acquiring module 4 are the same (S12). If the two pages are not the same (“Unmatched” at S12), the determining module 5 determines whether the page having the page number n+1 is ALL(1) (S13). If the page having the page number n+1 is not ALL(1) (No at S13), the determining module 5 adds “1” to the variable n (S14), and causes the acquiring module 4 to carry out the procedure of step S11 (or return to S11).

When processing is performed onto the last page having the page number n as the variable n, and the last page and the duplicated page of the last page (the (n+1)th page) are determined to be the same as a result of the comparison at step S12 (“Matched” at S12), the determining module 5 can confirm the duplicated page, and determines that the management information table is normally written (S15).

If the result of the comparison at step S12 is “Unmatched” (“Unmatched” at S12), and the page having the page number n+1 is determined to be ALL(1) at step S13 (Yes at S13), the determining operation has reached the last page to be written, without finding the duplicated page of the last page. This implies that the writing of the duplicated page of the last page (Page 3 Duplicated in FIG. 5) is unsuccessful, and the determining module 5 determines that the writing of the management information table is unsuccessful (S16).

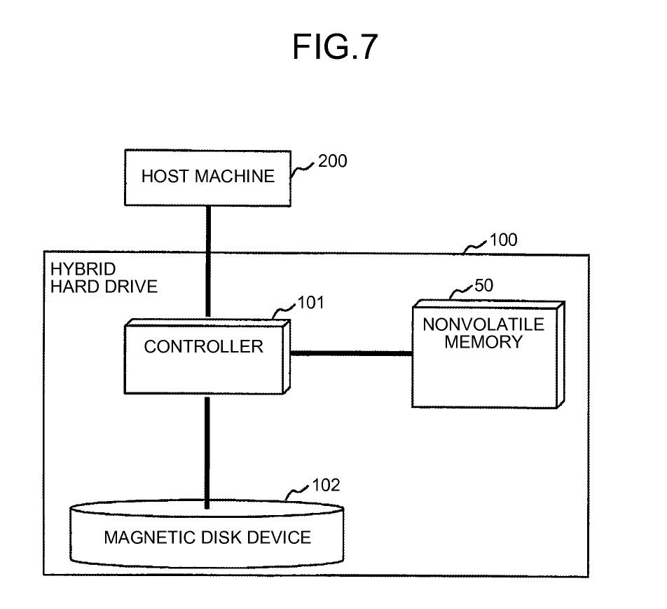

FIG. 7 illustrates the structure of a hybrid hard drive (a disk device) that combines a nonvolatile memory and a magnetic disk device, as an application of the nonvolatile memory of the first embodiment. A hybrid hard drive 100 comprises the controller 101 that controls a magnetic disk device 102 and the above described nonvolatile memory 50, the magnetic disk device 102, and the above described nonvolatile memory 50. The hybrid hard drive 100 manages the information management table on the side of the nonvolatile memory 50 in the above described manner.

Since the data necessary for activating and resuming the OS is stored in the nonvolatile memory 50 in advance, the host machine 200 can read data from the nonvolatile memory 50 via the controller 101, without having to wait for spinning-up of the magnetic disk device 102. Accordingly, the activation time can be shortened.

In the hybrid hard drive 100, the nonvolatile memory 50 can also be used as a cache for the magnetic disk device 102. During data inputting/outputting to and from the cache of the nonvolatile memory 50 via the controller 101, the magnetic disk device 102 can stop its motor. As a result, the power consumption can be reduced. Since the motor rotation time of the magnetic disk device 102 is shortened, the failure rate of the magnetic disk device 102 can be lowered.

Since the magnetic disk device 102 stops its motor as described above, the management information table in the region on the side of the nonvolatile memory 50 cannot be stored in the magnetic disk device 102, when data in the nonvolatile memory 50 is used.

In the first embodiment, the writing module 3 writes a management information table, and then duplicates and writes only the last page. However, all the pages in the management information table may be duplicated, and all the duplicates may be written. In such a case, the writing module 3 successively writes two-page data for each one page. For example, the writing module 3 writes Page 0, Page 0, Page 1, Page 1, . . . , Page 3, Page 3 in this order in the example case illustrated in FIG. 3.

In the first embodiment, the last page is duplicated, and the duplicated page of the last page is used in a determining operation. However, unique data for determination may also be used. In such a case, the unique data for determination needs to be stored beforehand in a predetermined management region in the NAND flash array 13. The writing module 3 writes the stored unique data for determination in the page after the page in which the last page of the management information table is written. The controller 101 (or the determining module 5) determines whether the stored unique data for determination and the written unique data for determination are the same, thereby determining whether the writing of the management information table is successful. Alternatively, the unique data for determination to be used may be acquired from the external host machine 200.

### Second Embodiment

In a second embodiment, before a management information table is written into the NAND flash array 13, the writing module 3 writes the number of pages to be used as table capacity information into a top word region in the top page in which the management information table is to be written. The writing module 3 starts writing the management information table in the region after the word region in which the table capacity information is written. The determining module 5 obtains the table capacity information. Based on the number of pages, the determining module 5 selects the last page number, and checks the data stored in the page having the last page number and the page after the last page. In this manner, the determining module 5 can perform determination without a comparison between pages.

Since the functional blocks and structure of a nonvolatile memory device according to the second embodiment are the same as or equivalent to those of the first embodiment, and therefore, explanation of them is omitted herein (see FIG. 1 and FIG. 2).

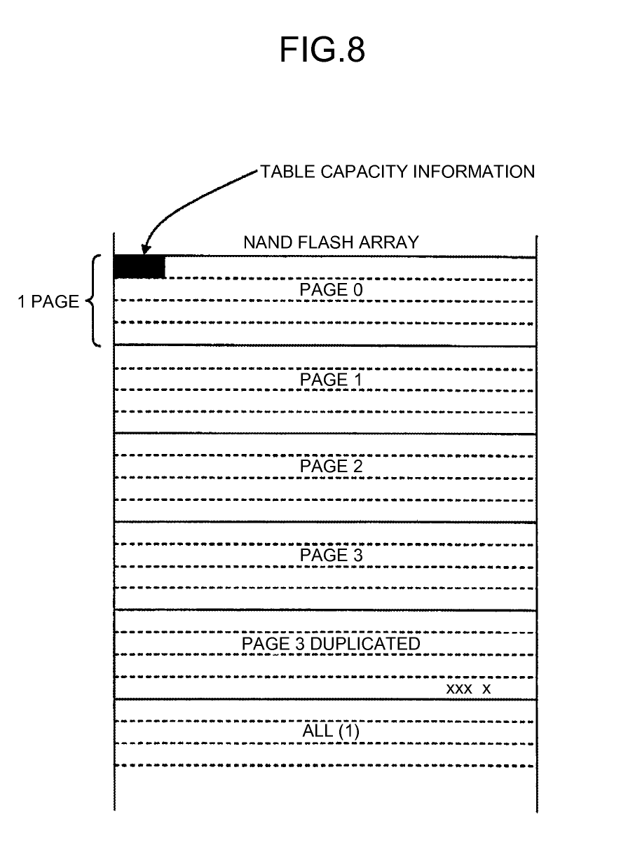

To explain the gist of a determining operation according to the second embodiment, FIG. 8 illustrates a storage condition of the management information table of the nonvolatile memory device 1. In FIG. 8, a management information table that uses the four pages of Page 0 to Page 3 is stored in a predetermined region of the NAND flash array 13. In the NAND flash array 13, the duplicated page of the last page (Page 3 Duplicated) is further stored in the page after the last page (Page 3) of the management information table. The second embodiment differs from the first embodiment in that the table capacity information is stored in the first work region of the top page in which the management information table is to be written.

FIG. 8 is also an example case where the writing of the duplicated page of the last page (Page 3 Duplicated) in the second embodiment is defective writing due to unexpected power discontinuity. As in the first embodiment, “x” represents defective write data in FIG. 8.

In the second embodiment, the determining module 5 determines whether the writing of the management information table is successful, by confirming that there is data written in the page (Page 3) indicated by the table capacity information and the page after that. Therefore, the data written the page after the last page is not necessarily a duplicated page of the last page, and may be formed with a set of data other than ALL(1).

In the second embodiment, even if the page after the page (Page 3) indicated by the table capacity information contains defective write data, the determining module 5 determines that the writing of the management information table is successful, because the determining module 5 recognizes the number of pages (up to Page 3) in the management information table from the table capacity information. If the page after the last page (Page 3) is ALL(1), on the other hand, the determining module 5 determines that the writing of the management information table is unsuccessful, because unexpected power discontinuity might have occurred during the writing of the last page.

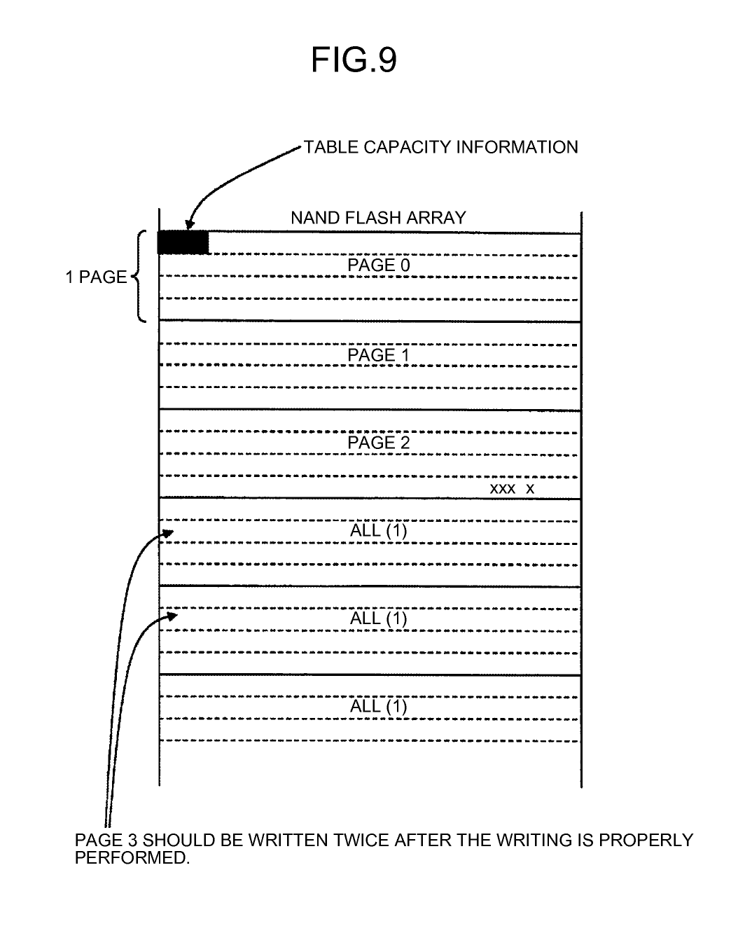

FIG. 9 illustrates an example case where a write defect is formed due to unexpected power discontinuity during the writing of the management information table in the second embodiment. In the example case illustrated in FIG. 9, the management information table that originally has pages up to Page 3 has a write defect in Page 2 due to unexpected power discontinuity, and “x” represents defective write data as in the above cases.

In the example case illustrated in FIG. 9, the page having the last page number (Page 3 in a normal operation) in accordance with the table capacity information is ALL(1). Therefore, the controller 101 (the determining module 5) cannot confirm the duplicated data, and determines that the writing of the management information table is unsuccessful.

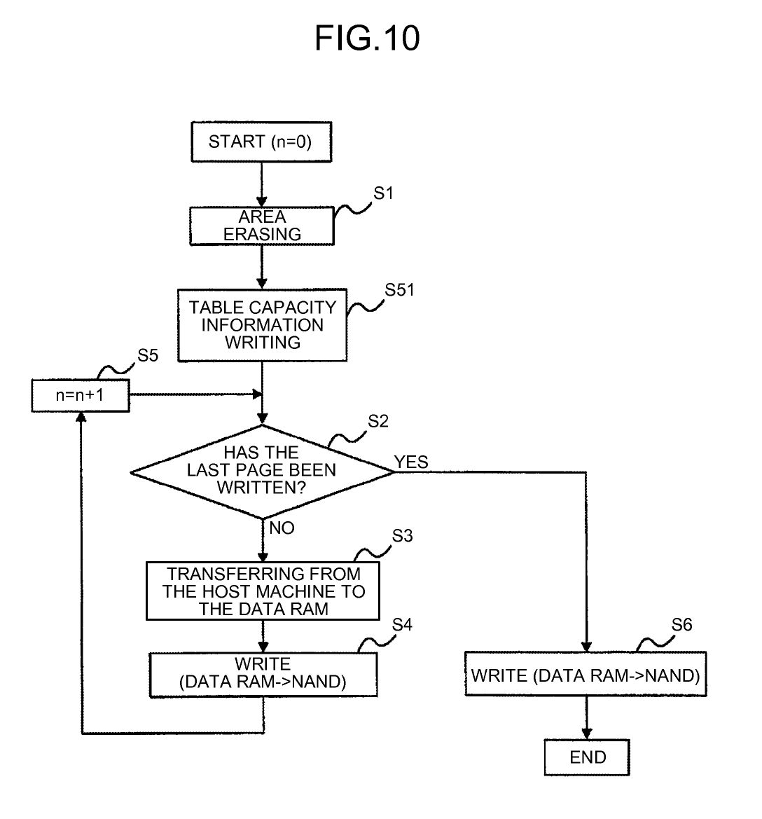

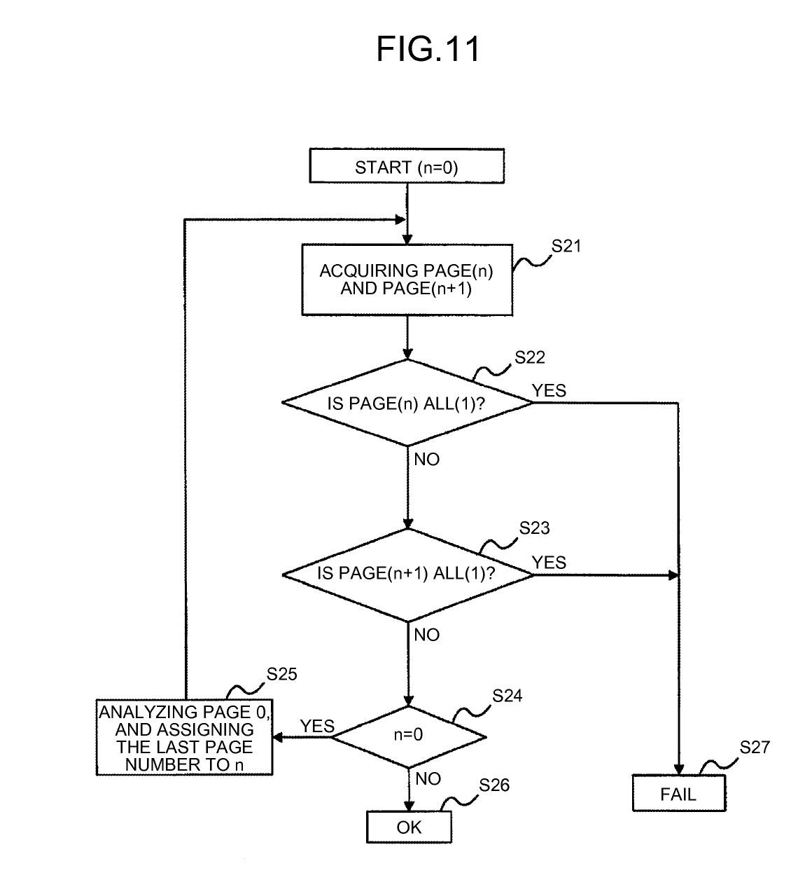

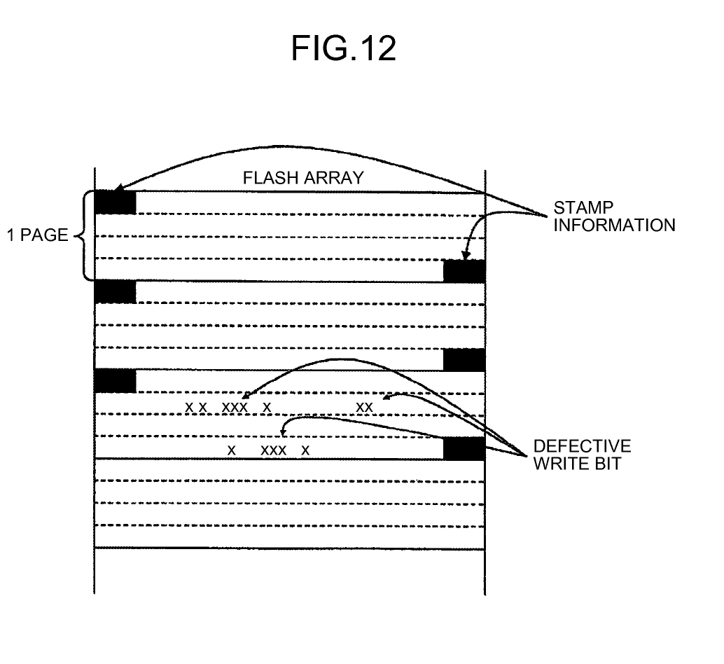

Referring now to the flowcharts of FIG. 10 and FIG. 11, operations according to the second embodiment are described.

Referring first to FIG. 10, a management information table updating operation is described. In accordance with the firmware program of the controller 101, the erasing module 2 erases the block storing a management information table (S1). After that, the writing module 3 writes the number of pages, into which a management information table is to be written, as the table capacity information into the top word region of the top page (S51). The procedures to be carried out thereafter are the same as those of the first embodiment, and therefore, explanation of them is omitted herein.

Referring now to the flowchart of FIG. 11, a determining operation is described. The acquiring module 4 acquires the nth page (Page 0, with “0” being the initial value of the variable n) and the (n+1) th page (Page 1) (S21). The determining module 5 determines whether the nth page acquired by the acquiring module 4 is ALL(1) (S22). If the nth page is not ALL(1) (No at S22), the determining module 5 determines whether the (n+1)th page is ALL(1) (S23). If the (n+1)th page is not ALL(1) (No at S23), the determining module 5 determines whether the variable n is the initial value “0” (S24). If the variable n is the initial value “0” (Yes at S24), the acquiring module 4 analyses the already acquired top page (Page 0). By doing so, the acquiring module 4 acquires the table capacity information stored in the first word region of Page 0, and, based on the table capacity information, assigns the page number (Page 3) of the last page to the variable n (S25).

After that, the operation returns to step S21, and the acquiring module 4 acquires the last page and the page after the last page (S21). The determining module 5 determines whether the last page is ALL(1) (S22), and determines whether the page after the last page is ALL(1) (S23). If the last page is not ALL(1) (No at S22), and the page after the last page is not ALL(1) (No at S23), the determining module 5 determines whether the variable n is the initial value “0” (S24). Since the page number of the last page is currently stored in the variable n, the result of step S24 is inevitably “No”.

Since the writing of the last page is completed (No at S22), and the writing of the page after the last page is also completed (No at S23) as described above, the determining module 5 determines that the writing of the management information table is successful (S26).

If the determination results at step S22 and step S23 are both “Yes”, the determining module 5 determines that the writing of the management information table is unsuccessful (S27).

In the second embodiment, the table capacity information is written into the top word region of the top page. However, the table capacity information may be written in any region, as long as the nonvolatile memory device 1 can control reading and writing in the region.

As in the first embodiment, the nonvolatile memory device according to the second embodiment can be mounted in a hybrid hard drive.

With the table capacity information being stored in a predetermined storage area as in the second embodiment, a check can be made to determine whether writing of a management information table is successful, without a comparison process. Accordingly, higher processing efficiency can be achieved.

In accordance with the above embodiments, a check can be correctly made to determine whether a management information table is defectively written, and destruction of effective data in the management information table can be minimized.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device configured to divide a management information table comprising addresses at which data are written into pages, and to write the management information table, the storage device comprising:
a writer configured to write a duplicate of a last page of the management information table after writing the management information table divided into the pages;
a receiving module configured to receive the last page and the duplicate of the last page written by the writer; and
a determining module configured to determine whether the writing of the management information table has been successful, either by comparing the last page and the duplicate of the last page received by the receiving module with each other, or by checking whether the duplicate of the last page has been written by the writer.

2. The storage device of claim 1, wherein
the writer is further configured to write information indicative of a number of pages of the divided management information table in a predetermined region, and
the receiving module is configured to select the last page of the management table written by the writer based on the information indicative of the number of pages and to receive the last page of the management table.

3. The storage device of claim 2, wherein
the predetermined region is a first word in a first page of the management information table.

4. The storage device of claim 1, further comprising
an eraser configured to erase an existing management information table in a block of pages,
wherein the writer is configured to write the management information table into the block erased by the eraser.

5. The storage device of claim 4, wherein
the eraser is configured to erase the block by setting all data in the block “1”.

6. The storage device of claim 1, wherein the storage device is a nonvolatile memory device comprising a NAND nonvolatile memory.

7. A storage device configured to divide a management information table comprising addresses at which data are written into pages and to write the management information table, the storage device comprising:
a writer configured to receive first unique data different from the management information table from an external source to write the first unique data, after writing the divided management information table;
a receiving module configured to receive the unique data written by the writer as first information, and further to receive second unique data as second information from the external source; and
a determining module configured to determine whether the writing of the management information table has been successful, either by comparing the first information and the second information with each other, or by checking whether the first unique data have been written by the writer.

8. A disk device with a storage device configured to divide a management information table comprising addresses at which data are written into pages, and to write the management information table, the disk device comprising:
a writer configured to write a duplicate of a last page of the management information table after writing the management information table divided into the pages;
a receiving module configured to receive the last page and the duplicate of the last page written by the writer; and
a determining module configured to determine whether the writing of the management information table has been successful, either by comparing the last page and the duplicate of the last page received by the receiving module with each other, or by checking whether the duplicate of the last page has been written by the writer.

9. The disk device of claim 8, wherein
the writer is further configured to write information indicative of a number of pages of the divided management information table in a predetermined region, and
the receiving module is configured to select the last page of the management table written by the writer based on the information indicative of the number of pages and to receive the last page of the management table.

10. The disk device of claim 9, wherein
the predetermined region is a first word in a first page of the management information table.

11. The disk device of claim 8, further comprising
an eraser configured to erase an existing management information table in a block of pages,
wherein the writer is configured to write the management information table into the block erased by the eraser.

12. The disk device of claim 11, wherein
the erasing module is configured to erase the block by setting all data in the block “1”.

13. The disk device of claim 8, wherein the disk device is a hybrid hard disk drive comprising a nonvolatile memory and a magnetic disk device.

14. A writing determining method of a management information table comprising addresses at which data are written at a storage device, the writing determining method comprising:
dividing the management information table into pages;
writing the divided pages of the management information table;
writing a duplicate of a last page of the management information table;
receiving the last page and the duplicate of the last page written; and
determining whether the writing of the management information table has been successful, either by comparing the received last page and the duplicate with each other, or by checking whether the duplicate of the last page has been written.

15. The writing determining method of claim 14, further comprising:
writing information indicative of a number of pages of the divided management information table in a predetermined region;
selecting the last page of the management table written, based on the information indicative of the number of pages; and
receiving the last page of the management table.

16. The writing determining method of claim 15, wherein
the predetermined region is a first word in a first page of the management information table.

17. The writing determining method of claim 14, further comprising:
erasing an existing management information table in a block of pages; and
writing the management information table into the block erased.

18. The writing determining method of claim 17, further comprising
erasing the block by setting all data in the block “1”.

19. A control device for a storage device configured to divide a management information table comprising addresses at which data are written into pages, and to write the management information table, the control device comprising:
a write controller configured to control writing of a duplicate of a last page of the management information table after the management information table divided into the pages is written;
a receiving controller configured to control receiving the last page and the duplicate of the last page written; and
a determining module configured to determine whether the writing of the management information table has been successful, either by comparing the last page and the duplicate of the last page received by the receiving controller with each other, or by checking whether the duplicate of the last page has been written.

20. A control device for a storage device configured to divide a management information table comprising addresses at which data are written into pages, and to write the management information table, the control device comprising:
a write controller configured to control receiving and writing first unique data different from the management information table from an external source, after the management information table divided into the pages is written;
an receiving controller configured to control receiving the first unique data that have been written as first information, and further receiving the second unique data as second information from the outside source; and
a determining module configured to determine whether the writing of the management information table has been successful, either by comparing the first information and second information with each other, or by checking whether the first unique data have been written.
